(19) United States
(12) Patent Application Publication
(10) Pub. No.: US 2025/0276392 A1
(43) Pub. Date: Sep. 4, 2025

(54) BAND SAW

(71) Applicant: MILWAUKEE ELECTRIC TOOL CORPORATION, Brookfield, WI (US)

(72) Inventors: Aidan W. Cole, Waunakee, WI (US); Ian H. Hogenkamp, Middleton, WI (US); David M. Pittman, Sussex, WI (US); Wesley S. Bassindale, Wauwatosa, WI (US); Terry L. Timmons, JR., Oconomowoc, WI (US); James A. Yaccarino, Greendale, WI (US); John C. Cameron, Milwaukee, WI (US)

(21) Appl. No.: 19/068,411

(22) Filed: Mar. 3, 2025

Related U.S. Application Data
(60) Provisional application No. 63/560,822, filed on Mar. 4, 2024.

(51) Int. Cl. B23D 53/12; B23D 55/06

(52) U.S. Cl. CPC B23D 53/12; B23D 55/065

(57) ABSTRACT

A band saw includes a housing having a handle configured to be grasped by a user during a cutting operation, a motor supported by the housing, and a drive wheel assembly rotationally driven by the motor. The drive wheel assembly has a drive wheel and a driven wheel. The band saw further includes an opening defined within the housing and located between the drive wheel and the driven wheel, an endless saw blade driven by the drive wheel assembly and configured to pass through the opening to cut a workpiece during the cutting operation, and a transmission assembly. The transmission assembly has an input member for receiving torque from the motor and an output member for transmitting torque to the drive wheel about a drive wheel axis. The transmission assembly includes at least one cycloidal gear stage.

### CROSS-REFERENCE TO RELATED APPLICATIONS

This application claims priority to U.S. Provisional Patent Application No. 63/560,822, filed Mar. 4, 2024, the entire content of which is incorporated herein by reference.

### FIELD OF THE INVENTION

The present invention relates to power tools, and more specifically to band saws.

### BACKGROUND OF THE INVENTION

Handheld band saws are used to cut a variety of workpieces, such as pipes, rods, studs, and blocks. A cordless, compact band saw allows for cutting operations in tight spaces or awkward angles for plumbing, electrical, remodeling, and HVAC applications.

### SUMMARY OF THE INVENTION

The invention provides, in one aspect, a band saw including a housing having a handle configured to be grasped by a user during a cutting operation, a motor supported by the housing, and a drive wheel assembly rotationally driven by the motor. The drive wheel assembly includes a drive wheel and a driven wheel. The housing defines an opening located between the drive wheel and the driven wheel. The drive wheel assembly drives an endless saw blade that is configured to pass through the opening to cut a workpiece during the cutting operation. The band saw further includes a transmission assembly having an input member for receiving torque from the motor and an output member for transmitting torque to the drive wheel about a drive wheel axis. The transmission assembly includes at least one cycloidal gear stage.

The invention provides, in another aspect, a band saw including a housing having a handle configured to be grasped by a user during a cutting operation and a motor supported by the housing. The motor has an outer rotor and an inner stator at least partially received within and surrounded by the outer rotor. The band saw further includes a drive wheel assembly rotationally driven by the motor. The drive wheel assembly has a drive wheel and a driven wheel. Moreover, the band saw includes an opening defined within the housing and located between the drive wheel and the driven wheel, an endless saw blade driven by the drive wheel assembly and configured to pass through the opening to cut a workpiece during the cutting operation, and a transmission assembly. The transmission assembly has an input member for receiving torque from the motor and an output member for transmitting torque to the drive wheel about a drive wheel axis. The transmission assembly includes at least one cycloidal gear stage.

The invention provides, in another aspect, a band saw including a housing having a handle configured to be grasped by a user during a cutting operation and a motor supported by the housing. The motor has an outer rotor and an inner stator at least partially received within and surrounded by the outer rotor. The band saw further includes a drive wheel assembly rotationally driven by the motor. The drive wheel assembly has a drive wheel and a driven wheel. Moreover, the band saw includes an opening defined within the housing and located between the drive wheel and the driven wheel, and an endless saw blade driven by the drive wheel assembly. The endless saw blade is configured to pass through the opening to cut a workpiece during the cutting operation.

### BRIEF DESCRIPTION OF DRAWING

FIG. 1 is perspective view of a band saw in accordance with an embodiment of the invention.

FIG. 2 is an exploded view of a portion of the band saw of FIG. 1.

FIG. 3 is a cross-sectional view of the band saw through section line 3-3 in FIG. 1.

FIG. 4 is an exploded perspective view of a motor for use with the band saw of FIG. 1.

FIG. 5 is a reverse exploded perspective view of the motor of FIG. 4.

FIG. 6 is a cross-sectional view of a band saw according to another embodiment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

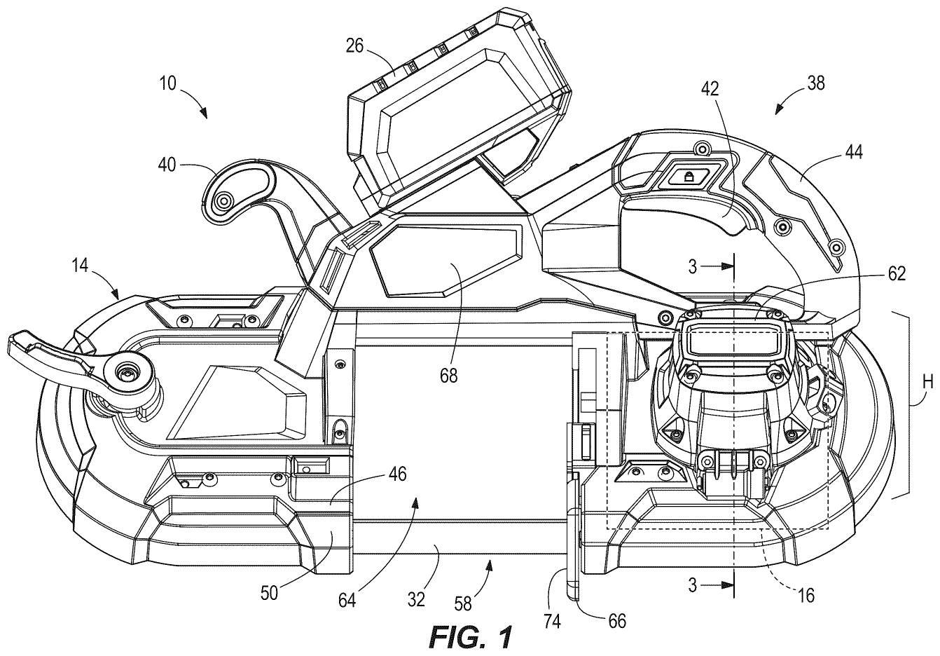

FIGS. 1-3 illustrate a band saw 10 including a housing 14 supporting a drive mechanism. The drive mechanism includes a motor 18 and a transmission assembly 16. In the illustrated construction of the band saw 10, the motor 18 is configured as a brushless DC (BLDC) electric motor, and the band saw 10 includes a removable, rechargeable battery pack 26 for supplying electrical current to the motor 18. The drive mechanism further includes a drive wheel assembly 30, which is driven by the motor 18 and transmitted torque via the transmission assembly 16. The motor 18, the transmission assembly 16, and the drive wheel assembly 30 are supported by the housing 14.

With reference to FIG. 1, the housing 14 includes a main or first handle 38 and an auxiliary or second handle 40. The first handle 38 is provided with a trigger 42 to selectively supply power to the band saw 10. The trigger 42 is disposed adjacent a gripping portion 44 of the first handle 38 where a user grasps the band saw 10 during a cutting operation. In the illustrated construction of the band saw 10, the battery pack 26 is supported by the housing 14 between the first handle 38 and the second handle 40. The trigger 42 is operable to control operation of the motor 18. Specifically, the battery pack 26 selectively supplies electrical current to the motor 18 when the trigger 42 is depressed.

The housing 14 of the band saw 10 also includes a deck 46 and a guard 50 coupled to the deck 46. The deck 46 and the guard 50 form a cavity (not shown) in which the drive wheel assembly 30 and an endless band saw blade 32 are at least partially positioned. The deck 46 defines a cut zone 58. The deck 46 and the guard 50 substantially cover the band saw blade 32 when the blade 32 is in a shielded position (i.e., when the blade 32 is not within the cut zone 58). However, the deck 46 and the guard 50 do not cover the band saw blade 32 when the blade 32 is in an exposed position (i.e., when the blade 32 passes through the cut zone 58). In the exposed position, the blade 32 is fully exposed and unobstructed by the guard 50, allowing workpieces to be cut when entering the cut zone 58. The band saw 10 further includes a shoe 66 coupled to the housing 14 and having a support surface 74 against which a work piece is abutted during a cutting operation.

The housing 14 includes a motor housing portion 62 extending from the deck 46. The motor housing portion 62 encloses the motor 18. The motor housing portion 62 extends a height dimension H (FIG. 1) from the deck 46. In the illustrated embodiment, the height dimension His between 20 mm and 30 mm. More particularly, the height dimension His 25.5 mm. As explained in further detail below, the length of the transmission assembly 16 is less than that of a traditional band saw in which a multi-stage planetary transmission is positioned between a drive wheel and the electric motor, which requires a motor housing height much greater than the height dimension H in the band saw 10.

With continued reference to FIG. 1, the housing 14 of the band saw 10 includes an electronics housing portion 68 coupled to the deck 46 and disposed above the cut zone 58. The electronics housing portion 68 is also disposed between the first handle 38 and the second handle 40. Electronic components (e.g., a power and/or control printed circuit board; not shown) used to operate the band saw 10 are housed within the electronics housing portion 68. A battery receptacle (not shown) is formed on the electronics housing portion 68 and configured to receive the battery pack 26. As such, the electronic components within the electronics housing portion 68 electrically connect the battery pack 26 to the motor 18.

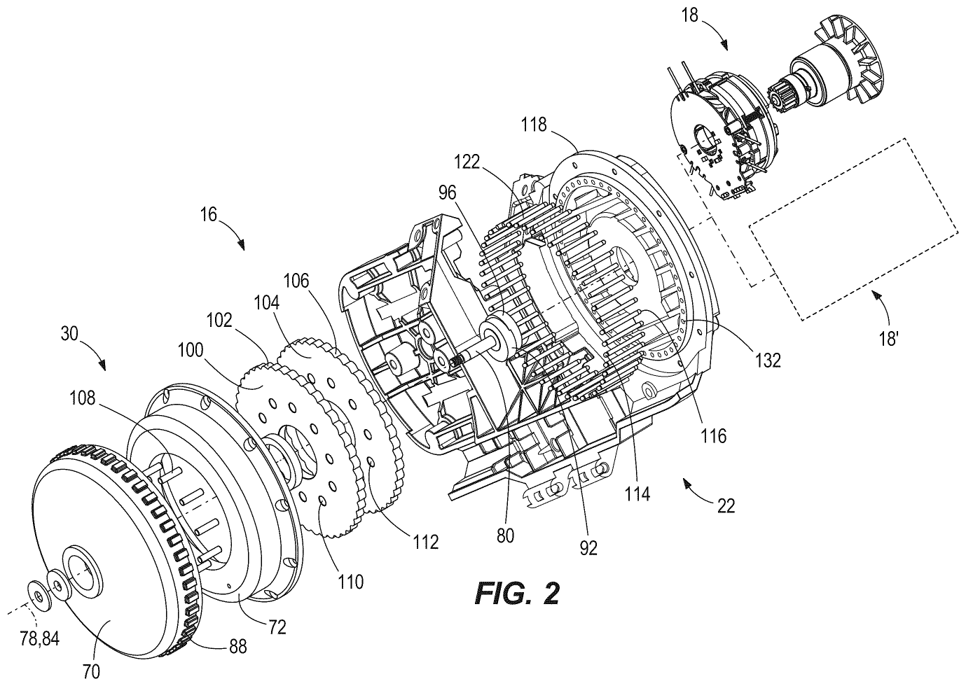

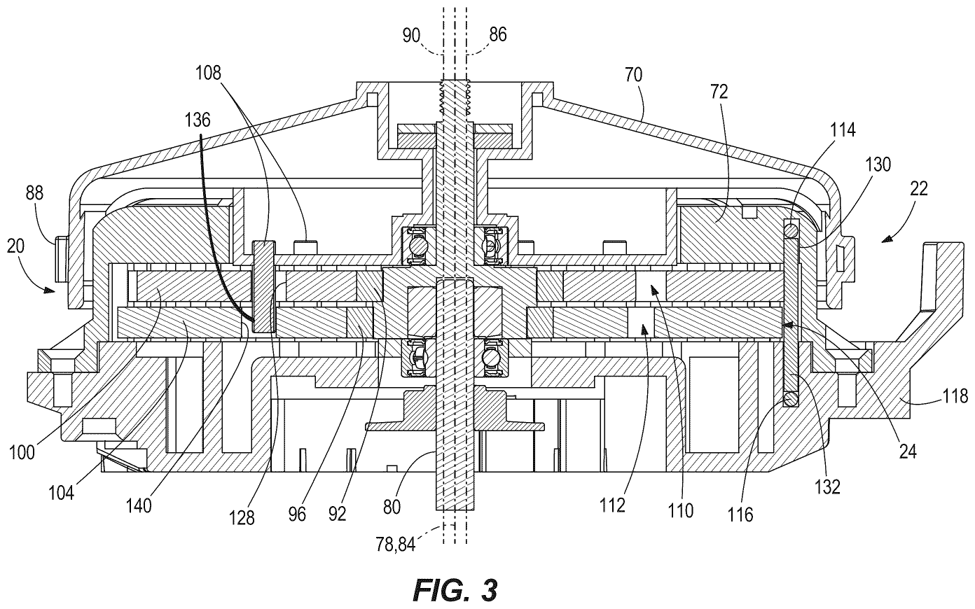

With reference to FIGS. 2 and 3, the drive wheel assembly 30 includes a drive wheel 70 that is driven by the motor 18 and a driven wheel (not shown) that is driven by the drive wheel 70 via the saw blade 32. Portions of the drive wheel 70 and the driven wheel are covered by the deck 46 and the guard 50. The cut zone 58 is located between the drive wheel 70 and the driven wheel, and coincides with an opening 64 in the housing 14 and/or deck 46 through which the saw blade 32 passes. The drive wheel 70 rotates about a drive wheel axis 78 that is coaxial with a rotational axis or a first axis 84 of an input member or input shaft 80 of the transmission assembly 16 which, in turn, receives torque from the motor 18. As is described in detail below, the transmission assembly 16 receives torque from the motor 18 and provides torque through an output member to the drive wheel 70, causing the drive wheel 70 to rotate about the drive wheel axis 78. A tire 88 is coupled to the outer peripheral surface of each of the drive wheel 70 and the driven wheel. The tire 88 grips the saw blade 32 during a cutting operation to reduce or prevent slippage between the drive wheel 70 and the driven wheel, respectively, with the saw blade 32. The saw blade 32 is driven by the drive wheel assembly 30 and passes through the cut zone 58 during the cutting operation.

With continued reference to FIGS. 2 and 3, the transmission assembly 16 includes a single stage cycloidal gear set 20. In other embodiments, the transmission assembly 16 may include two or more cycloidal gear stages. The transmission assembly 16 includes a transmission housing 22 coupled to the housing 14 and/or the deck 46. In the illustrated embodiment, the transmission housing 22 includes a frame 118 and a cover 72 affixed to the frame 118 (e.g., with fasteners). In other embodiments, the frame 118 and cover 72 may be affixed using integral features on the frame 118 and cover 72, respectively (e.g., snap-fits). The single stage cycloidal gear set 20 is housed in the transmission housing 22.

The single stage cycloidal gear set 20 includes a first cam 92 and a first disc 100. The first cam 92 is coupled to the input shaft 80, such that the first cam 92 is rotated about the first axis 84 by the input shaft 80. The first cam 92 drives the first disc 100 into an orbiting motion about the first axis 84. The first disc 100 defines a second axis 86 through a center of the first disc 100. The first disc 100 rotates about the second axis 86 and orbits about the first axis 84 in response to rotation of the first cam 92 about the first axis 84.

With continued reference to FIGS. 2-3, the transmission assembly 16 includes a plurality of cylindrical pins 122 having a first end 114 and a second end 116 opposite the first end 114. The cylindrical pins 122 define a circular cross-section when viewed along the drive wheel axis 78. The first end 114 of each of the cylindrical pins 122 is anchored in a blind bore 130 of the cover 72. The second end 116 of each of the cylindrical pins 122 is anchored in a blind bore 132 the frame 118. As such, the cylindrical pins 122 extend between the cover 72 and the frame 118 and are affixed within the transmission housing 22. In some embodiments, the cylindrical pins 122 are slip-fit with the blind bores 130, 132 of the cover 72 and the frame 118. As the cover 72 and the frame 118 are secured together during assembly, a nominal clamping force is applied to the cylindrical pins 122 to restrict the movement of the cylindrical pins 122 within the transmission housing 22. In other embodiments, the cylindrical pins 122 may be press-fit into the blind bores 130, 132 of the cover 72 and/or the frame 118.

The use of cylindrical pins 122 reduces manufacturing costs of the transmission assembly 16 when compared to radially inward extending teeth to engage with a portion of the single stage cycloidal gear set 20. The use of radially inward extending teeth, as known in the prior art, requires additional machining due to the complex geometry of the teeth. The additional machining increases overall time and manufacturing cost of the transmission housing 22. The cylindrical pins 122 used in the disclosed embodiment may be constructed from a cylindrical bar stock material (e.g., Aluminum, steel, etc.). The cylindrical bar may be cut to length and affixed to the transmission housing 22 using any of the methods described above at a reduced cost.

With reference to FIG. 2, the drive wheel 70 includes a plurality of drive lugs 108 extending from the drive wheel 70 in a direction parallel with the drive wheel axis 78. The drive lugs 108 include an outer diameter 136 that form a generally cylindrical cross-section viewed along the drive wheel axis 78. The drive lugs 108 are coupled to the drive wheel 70 for co-rotation about the drive wheel axis 78.

With reference to FIGS. 2-3, the first disc 100 includes a first plurality of apertures 110 to receive the drive lugs 108. The apertures 110 define an inner diameter 128 that is greater than the outer diameter 136 of the drive lugs 108 to provide clearance for the drive lugs 108 when received in the corresponding apertures 110 to not obstruct the rotational and orbital (i.e., cycloidal) movement of the first disc 100 within the transmission housing 22. Specifically, the inner diameter 128 of the apertures 110 imparts a rotational force on each of the drive lugs 108, thereby applying torque to the drive wheel 70 to cause it to rotate. The first disc 100 further includes a first plurality of rounded teeth 102 on an outer circumference of the first disc 100. The teeth 102 selectively engage the cylindrical pins 122 as the first disc 100 both rotates and orbits within the transmission housing 22.

The transmission assembly 16 includes a vibration attenuation assembly 24 to reduce vibration caused by the single stage cycloidal gear set 20. The vibration attenuation assembly 24 includes a second cam 96 and a second disc 104. The input shaft 80 provides a torque input from the motor 18 to the second cam 96, such that the second cam 96 rotates about the first axis 84. The second disc 104 defines a third axis 90 through a center of the second disc 104. The second disc 104 rotates about the third axis 90 and orbits about the first axis 84 in response to rotation of the second cam 96 about the first axis 84. The vibration attenuation assembly 24 is operated 180 degrees out of phase with the single stage cycloidal gear set 20. Specifically, the first cam 92 is 180 degrees out of phase with the second cam 96 and the first disc 100 is 180 degrees out of phase with the second disc 104, thereby counteracting unbalanced forces caused by the cycloidal motion of the single stage cycloidal gear stage 20 and attenuating resultant vibration.

The second disc 104 includes a second plurality of apertures 112 having an inner diameter 140. The inner diameter 140 of the apertures 112 is greater than the outer diameter 136 of the drive lugs 108 to provide clearance during operation. The drive lugs 108 extend through the apertures 110 and the apertures 112. The second disc 104 further includes a second plurality of rounded teeth 106 on an outer circumference of the second disc 104. The teeth 106 selectively engage with the cylindrical pins 122 as the second disc 104 both rotates and orbits within the transmission housing 22.

The cylindrical pins 122 include a number of pins N, and the first disc 100 and the second disc 104 include a number of teeth M, equal to one less than the number of pins N (i.e., M=N−1). The number of pins N and the number of teeth M are to mesh upon rotation of the input shaft 80. When the input shaft 80 rotates, a reduction ratio R is governed by the following equation:

$$R = \frac{M}{N - M}$$

In the illustrated embodiment shown in FIG. 2, the cylindrical pins 122 includes 45 pins. The first disc 100 and the second disc 104 each include 232 teeth. Therefore, the transmission assembly 16 provides a reduction ratio of 232:1. In other words, the first disc 100 rotates about the drive wheel axis 78 to rotate the drive lugs 108 about 8.18 degrees for every 360 degree rotation of the first cam 92. In other embodiments, the first disc 100 may provide any other reduction ratio R as desired.

In operation, the user depresses the trigger 42 to activate the motor 18 with electrical current from the battery pack 26. The motor 18 provides torque to the shaft 80, causing it to rotate about the first axis 84. With the first cam 92 being coupled for co-rotation with the shaft 80, the first cam 92 is co-rotated with the shaft 80. The first disc 100 is driven to orbit about the first axis 84 due to an eccentric offset of the first cam 92 with the shaft 80. The first disc 100 is also driven to rotate about the second axis 86 defined through the center of the first disc 100. The cycloidal motion of the single cycloidal gear stage 20 is a result of the first disc 100 rotating about the second axis 86 and orbiting about the first axis 84 simultaneously. The cycloidal motion of the first disc 100 within the transmission housing 22, with the drive lugs 108 received within the apertures 110 in the first disc 100, is transmitted to the drive wheel 70 as rotation. The shaft 80 also provides a torque input to the vibration attenuation assembly 24. With the second cam 96 being coupled for co-rotation with the shaft 80, the second cam 96 is co-rotated with the shaft 80. The second disc 104 is driven to orbit about the first axis 84 due to an eccentric offset of the second cam 96 with the shaft 80. The second disc 104 is also driven to rotate about the third axis 90 defined through the center of the second disc 104. The cycloidal motion of the vibration attenuation assembly 24 is a result of the second disc 104 rotating about the third axis 90 and orbiting about the first axis 84 simultaneously. In use, the vibration attenuation assembly 24 moves 180 degrees out of phase with the single cycloidal gear stage 20. Therefore, the vibration attenuation assembly 24 counteracts unbalanced forces caused by the cycloidal motion of the single stage cycloidal gear stage 20 and attenuates resultant vibration.

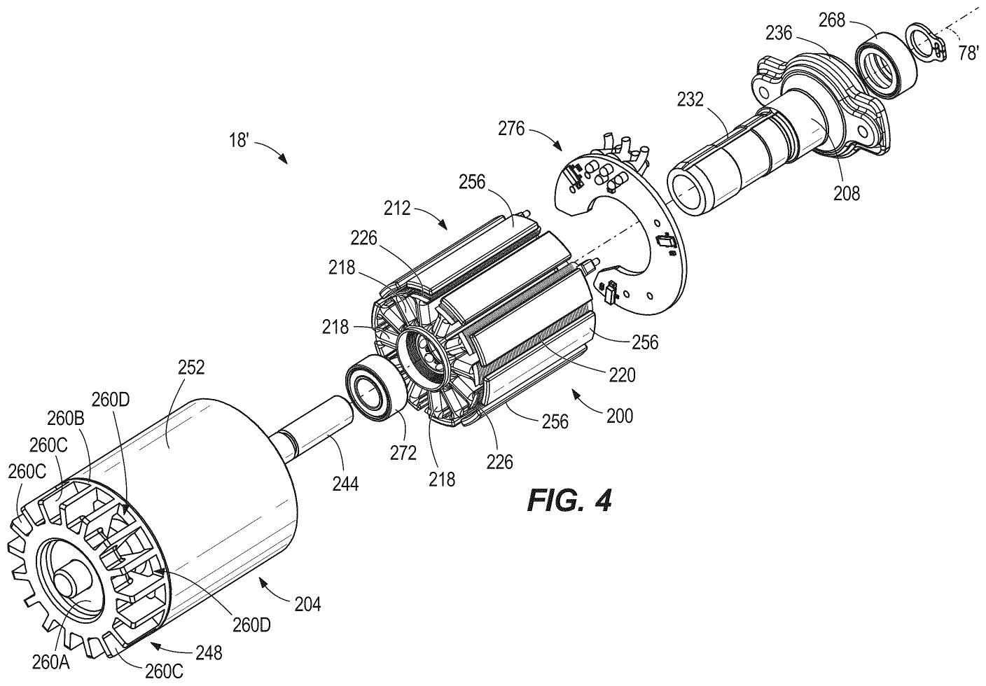

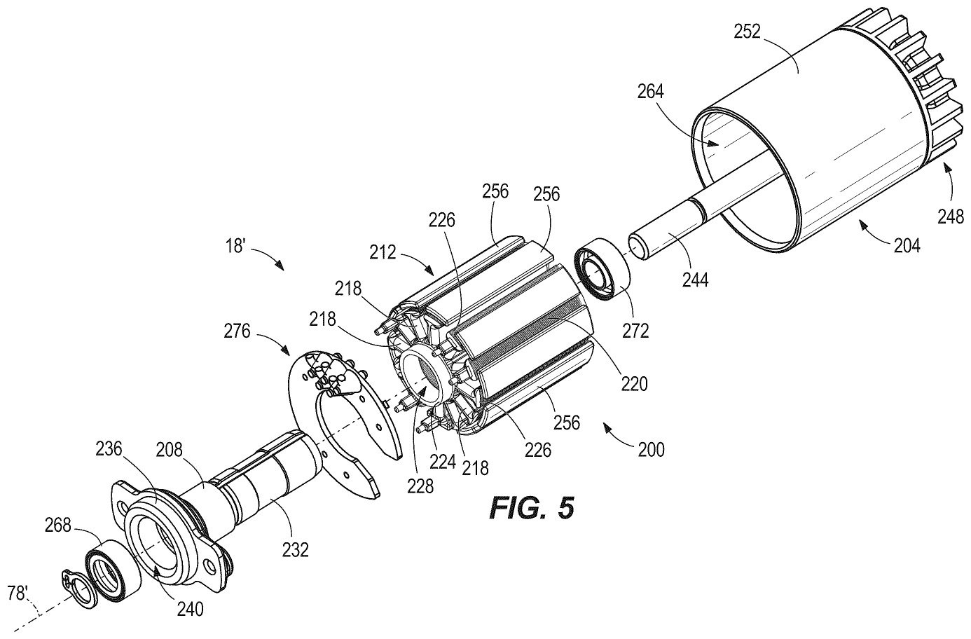

FIGS. 4 and 5 illustrate an alternative motor 18′ that may be incorporated into the band saw 10 of FIGS. 1-3. The motor 18′ is a brushless direct current (“BLDC”) electric motor with a stator 200 and a rotor 204 that is rotatable with respect to the stator 200 about an axis 78′. The BLDC electric motor 18′ is an “outer rotor” BLDC electric motor with the rotor 204 generally surrounding the stator 200. As such, the rotor 204 is an outer rotor 204 and the stator 200 is an inner stator 200 that is at least partially received within and generally surrounded by the outer rotor 204.

The stator 200 includes a stator mount 208, a stator core assembly 212 fixedly supported by the stator mount 208, and a plurality of wires or stator windings that define a plurality of coils 218. The stator core assembly 212 includes a stator core 220 formed, in the illustrated construction, by a stack of laminations, and an insulator 224 (FIG. 5) molded to the stator core 220. The stator core 220 includes a plurality of teeth 226 in which the coils 218 are formed about the teeth 226 and insulated therefrom by the insulator 224. The stator core 220 defines a core central bore 228 that extends longitudinally therethrough. The stator mount 208 includes an elongated stator support portion 232 and a motor support portion 236 located at one longitudinal end of the stator support portion 232. The stator support portion 232 is tubular in shape and supports the stator core assembly 212. More specifically, the core central bore 228 of the stator core 220 receives the stator support portion 232, such that the stator core assembly 212 is rigidly supported about the stator support portion 232. In some examples, the stator core 220 can receive the stator support portion 232 by press fit or interference fit. In other examples, the stator support portion 232 can be affixed to the stator core 220 by a molding process. The stator mount 208 further defines a mount central bore 240 that extends longitudinally therethrough, including through both the stator support portion 232 and the motor support portion 236.

With continued reference to FIGS. 4 and 5, the rotor 204 includes a central rotor shaft 244, a rotor frame 248, a tubular rotor body 252, and a plurality of permanent magnets 256. The rotor frame 248 is annular in shape and includes a central portion 260A that is affixed to the rotor shaft 244. An outer peripheral portion 260B of the rotor frame 248 is affixed to the rotor body 252. As such, the rotor frame 248 affixes the rotor body 252 to the rotor shaft 244 for co-rotation therewith. A plurality of radially and axially extending blades 260C extend between and connect the central portion 260A to the outer peripheral portion 260B, and a plurality of airflow apertures 260D are defined between each pair of adjacent blades 260C. The blades 260C operate as a fan to generate an airflow that passes through the airflow apertures, thereby cooling the motor 18′. In some embodiments, the rotor frame 248 can be formed from a metal or metal alloy such as, e.g., zinc or steel. In other embodiments, the rotor frame 248 can be molded from a resin material.

The rotor body 252 is tubular in shape and defines a central cavity 264. The permanent magnets 256 are fixedly supported on a radially inner surface of the rotor body 252. When assembled, the rotor body 252 is located radially outward from the stator 200 and surrounds portions of the stator 200, including the stator core assembly 212, the coils, and portions of the stator mount 208. Portions of the stator 200, including all or generally most of the stator core assembly 212, are received into the central cavity 264 of the rotor body 252.

The rotor shaft 244 is rotatably supported relative to the stator 200 by two bearings including a first bearing 268 and a second bearing 272. As such, the rotor 204 (i.e., including the rotor shaft 244, the rotor frame 248, the rotor body 252, and the magnets 256) rotates relative to the stator 200. When the motor 18′ is supported within the motor housing portion 62 of the band saw 10, the rotor 204 is rotatable relative to both the motor housing portion 62 and the stator 200, whereas the stator 200 does not rotate relative to the motor housing portion 62. The rotor shaft 244 extends centrally through the stator 200, both through the core central bore 228 and the mount central bore 240.

The motor 18′ further includes an annular printed circuit board assembly (PCBA) 276 affixed to the insulator 224 of the stator 200, as will be described in greater detail below. The PCBA 276 can include at least one position sensor, such as a Hall effect sensor, operable to detect a position of the permanent magnets 256 of the rotor 204. In addition, or alternatively, the PCBA 276 can include a plurality of switching circuits (e.g., Field-Effect Transistors (FETs)) operable to electrically commutate the motor 18′.

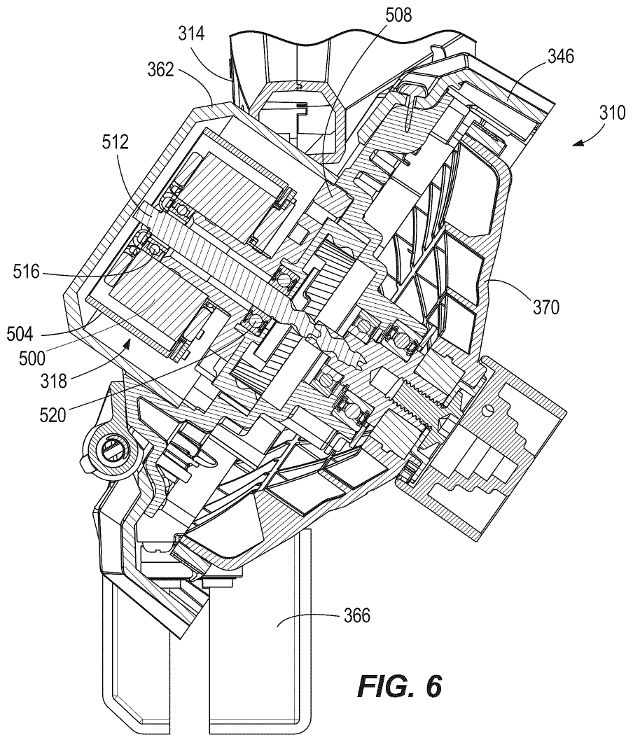

FIG. 6 illustrates a band saw 310 according to another embodiment. The band saw 310 is similar in some aspects to the band saw 10 of FIGS. 1-3 described above, and features of the band saw 310 corresponding with features of the band saw 10 are given like reference numerals plus ‘300.’ In addition, the following description focuses primarily on differences between the band saw 310 and the band saw 10, and it should be understood that features of the band saw 10 may be incorporated into the band saw 310, and vice versa.

The band saw 310 includes a housing 314 supporting a drive mechanism. The drive mechanism includes a motor 318 and a transmission assembly (not shown). The transmission assembly may take the form of a multi-stage planetary transmission or a transmission including the single stage cycloidal gear set 20 of FIGS. 2 and 3. In the illustrated construction of the band saw 310, the motor 318 is disposed within a motor housing portion 362 of the housing 314 and is configured as an “outer rotor” BLDC electric motor. The motor 318 has a stator 500 and a rotor 504 that is rotatable with respect to the stator 500. The rotor 504 is an outer rotor 504 and the stator 500 is an inner stator 500 that is at least partially received within and generally surrounded by the outer rotor 504. The stator 500 is supported by a stator frame 508 that may be coupled to the housing 314 or the motor housing portion 362. Also, the rotor 504 has a rotor shaft 512 operably coupled to the transmission assembly to rotate a drive wheel 370 during operation of the band saw 310. The rotor shaft 512 is rotatably supported relative to the stator 500 by two bearings including a first bearing 516 and a second bearing 520.

Due to the motor 18′, 318 being an “outer rotor” BLDC electric motor, the size of the band saw 10, 310 is reduced. In comparison to conventional band saws that may have an “inner rotor” BLDC motor, the band saw 10, 310 has at least 15 fewer parts and weighs at least 0.5 lbs. less. In this alternate embodiment, the height dimension His about 22 mm. As such, in some embodiments, the motor 18′, 318 may nest within the drive wheel 70, 370 to thereby reduce the size of the band saw 10, 310. Size reduction of the band saw 10, 310 gives the user the ability to perform a flush cutting operation by reducing the height of the housing 14, 314 up to about ⅜ of an inch compared to known band saws with inner rotor BLDC motors. Size reduction also increases durability of the band saw 10, 310 by reducing the drop risk of the band saw 10, 310.

In addition, the configuration of the motor 18′, 318 yields the removal of one or more gears from the transmission assembly 16. Efficiency of a cutting performance of the band saw 10, 310 is thereby increased and leads to an exceptional run time of the band saw 10, 310. Removal of one or more gears also improves manufacturability and eases the process of assembling the band saw 10, 310 by reducing cost of assembly and increasing speed of the assembling process.

Although the invention has been described in detail with reference to certain preferred embodiments, variations and modifications exist within the scope and spirit of one or more independent aspects of the invention as described.

Various features of the present invention are set forth in the following claims.

What is claimed is:

1. A band saw comprising:
a housing including a handle configured to be grasped by a user during a cutting operation;
a motor supported by the housing;
a drive wheel assembly rotationally driven by the motor, the drive wheel assembly including a drive wheel and a driven wheel;
an opening defined within the housing and located between the drive wheel and the driven wheel;
an endless saw blade driven by the drive wheel assembly and configured to pass through the opening to cut a workpiece during the cutting operation; and
a transmission assembly having an input member for receiving torque from the motor and an output member for transmitting torque to the drive wheel about a drive wheel axis,
wherein the transmission assembly includes at least one cycloidal gear stage.

2. The band saw of claim 1, wherein the at least one cycloidal gear stage of the transmission assembly includes
a first cam coupled to the input member for rotation about a first axis, and
a first disc defining a second axis and configured to both rotate about the second axis and orbit about the first axis, thereby undergoing cycloidal motion, in response to rotation of the first cam about the first axis.

3. The band saw of claim 2, wherein the transmission assembly further includes
a transmission housing in which the first cam and the first disc are located, and
a plurality of cylindrical pins affixed within the housing that are engaged by teeth on the first disc during cycloidal motion of the first disc.

4. The band saw of claim 3, wherein the transmission housing includes a frame and a cover coupled to the frame, and wherein the cylindrical pins extend between the frame and the cover.

5. The band saw of claim 3, wherein the drive wheel includes a plurality of drive lugs extending therefrom in a direction parallel to the drive wheel axis, wherein the first disc includes a plurality of apertures in which the drive lugs are received, respectively, and wherein an inner diameter of the apertures is greater than an outer diameter of the drive lugs to provide clearance for the first disc during the cycloidal motion thereof.

6. The band saw of claim 3, wherein the plurality of cylindrical pins includes N pins and the first disc includes N−1 teeth.

7. The band saw of claim 3, wherein the plurality of cylindrical pins includes 45 pins and the first disc includes 232 teeth to provide a gear ratio of the transmission assembly of 232:1.

8. The band saw of claim 2, wherein the transmission assembly further includes a vibration attenuating assembly configured to move out of phase with the first cam and the first disc.

9. The band saw of claim 8, wherein the vibration attenuating assembly includes
a second cam coupled to the input member for rotation about the first axis, the second cam being 180 degrees out of phase with the first cam, and
a second disc defining a third axis and configured to both rotate about the third axis and orbit about the first axis, thereby undergoing cycloidal motion, in response to rotation of the second cam about the first axis.

10. The band saw of claim 9, wherein the drive wheel includes a plurality of drive lugs extending therefrom in a direction parallel to the drive wheel axis, wherein the first disc includes a first plurality of apertures and the second disc includes a second plurality of apertures, wherein the drive lugs are received in both the first and second pluralities of apertures, and wherein an inner diameter of the first plurality of apertures and an inner diameter of the second plurality of apertures are greater than an outer diameter of the drive lugs to provide clearance for each of the first disc and the second disc during the cycloidal motion thereof.

11. The band saw of claim 1, wherein the housing includes a deck and a motor housing portion extending from the deck, and wherein a height dimension of the motor housing portion from the deck is 25.5 mm.

12. A band saw comprising:
a housing including a handle configured to be grasped by a user during a cutting operation;
a motor supported by the housing, the motor including
an outer rotor, and
an inner stator at least partially received within and surrounded by the outer rotor;
a drive wheel assembly rotationally driven by the motor, the drive wheel assembly including a drive wheel and a driven wheel;
an opening defined within the housing and located between the drive wheel and the driven wheel;
an endless saw blade driven by the drive wheel assembly and configured to pass through the opening to cut a workpiece during the cutting operation; and
a transmission assembly having an input member for receiving torque from the motor and an output member for transmitting torque to the drive wheel about a drive wheel axis,
wherein the transmission assembly includes at least one cycloidal gear stage.

13. The band saw of claim 12, wherein the at least one cycloidal gear stage of the transmission assembly includes
a first cam coupled to the input member for rotation about a first axis, and
a first disc defining a second axis and configured to both rotate about the second axis and orbit about the first axis, thereby undergoing cycloidal motion, in response to rotation of the first cam about the first axis.

14. The band saw of claim 13, wherein the drive wheel includes a plurality of drive lugs extending therefrom in a direction parallel to the drive wheel axis, wherein the first disc includes a plurality of apertures in which the drive lugs are received, respectively, and wherein an inner diameter of the apertures is greater than an outer diameter of the drive lugs to provide clearance for the first disc during the cycloidal motion thereof.

15. The band saw of claim 13, wherein the transmission assembly further includes a vibration attenuating assembly configured to move out of phase with the first cam and the first disc.

16. The band saw of claim 15, wherein the vibration attenuating assembly includes
a second cam coupled to the input member for rotation about the first axis, the second cam being 180 degrees out of phase with the first cam, and
a second disc defining a third axis and configured to both rotate about the third axis and orbit about the first axis, thereby undergoing cycloidal motion, in response to rotation of the second cam about the first axis.

17. A band saw comprising:
a housing including a handle configured to be grasped by a user during a cutting operation;
a motor supported by the housing, the motor including
an outer rotor, and
an inner stator at least partially received within and surrounded by the outer rotor;
a drive wheel assembly rotationally driven by the motor, the drive wheel assembly including a drive wheel and a driven wheel;
an opening defined within the housing and located between the drive wheel and the driven wheel; and
an endless saw blade driven by the drive wheel assembly and configured to pass through the opening to cut a workpiece during the cutting operation.

18. The band saw of claim 17, wherein the outer rotor has a rotor body and a plurality of permanent magnets supported on the rotor body, and wherein the inner stator has a stator mount, a stator core supported by the stator mount, and a plurality of coils, and wherein the rotor body surrounds the stator core, portions of the stator mount, and the plurality of coils.

19. The band saw of claim 17, wherein the outer rotor has a rotor shaft rotatably supported by at least one bearing such that the outer rotor rotates relative to the inner stator.

20. The band saw of claim 17, wherein the outer rotor includes a rotor frame having a plurality of blades and a plurality of apertures defined between adjacent blades, the plurality of blades configured to generate an airflow that passes through the apertures to cool the motor.
